(19) United States
(12) Patent Application Publication
(10) Pub. No.: US 2013/0146159 A1
(43) Pub. Date: Jun. 13, 2013

(54) FLOW CONTROLLABLE CONNECTOR FOR HOME APPLIANCES

(71) Applicant: Gwan Ho RO, Seoul (KR)

(72) Inventor: Gwan Ho RO, Seoul (KR)

(21) Appl. No.: 13/398,267

(22) Filed: Feb. 16, 2012

(30) Foreign Application Priority Data
Dec. 12, 2011 (KR) 2011-132786

(51) Int. Cl. F16K 15/02; F16K 51/00

(52) U.S. Cl. 137/538; 251/153

(57) ABSTRACT

A flow controllable connector for home appliances, which diverges or extends a passage of fluid by fastening an inlet having a first passage and an outlet having a second passage to tubes using fastening devices. The connector includes a control device disposed between the inlet and the outlet in order to prevent the fluid from flowing back as well as to control a flow rate. The control device performs both the function of preventing the fluid from flowing back and the function of controlling the pressure of the fluid. This makes it possible to prevent an electric/electronic sub-assembly from malfunctioning or abnormally operating, thereby increasing the longevity and reliability thereof.

### CROSS REFERENCE TO RELATED APPLICATION

The present application claims priority from Korean Patent Application Number 10-2011-132786 filed on Dec. 12, 2011, the entire contents of which application are incorporated herein for all purposes by this reference.

### BACKGROUND OF THE INVENTION

1. Field of the Invention

The present invention relates to a connector, which is provided on a passage of electronics in order to diverge or extend tubes, and more particularly, to a flow controllable connector for home appliances in which a control device for performing both the function of supplying fluid at a constant rate and the function of preventing backflow is provided in order to improve the reliability of home appliances.

2. Description of Related Art

In general, a connector for home appliances is a connecting device that is used in the process of diverging or extending a fluid passage of an electric/electronic sub-assembly, which needs fluid. This connector is required to be coupled to a connecting portion of a tube with one touch as well as to provide an amount of fastening force that is sufficient to maintain the water-tightness of the tube and prevent the tube from being dislodged.

In the connector, however, when backpressure occurs as a reaction in the process of supplying the fluid or the process of blocking the supply of the fluid, the fluid may flow back. In addition, when the pressure at which the fluid is supplied is changed, the fluid may not be supplied at a constant rate. These are major reasons that degrade the performance of the electric/electronic sub-assembly.

Therefore, proposed was a method that prevents a backflow from occurring while the connector is operating or the fluid from being abnormally supplied. According to this method, a backflow prevention device that prevents the fluid from flowing back or a flow control device that controls the flow rate of the fluid is added to the connector during the process in which the connector is fabricated.

However, in the process of fabricating the connector, if the backflow prevention device and the flow control device are separately configured, the passage of the connector becomes complicated and surrounding components are added, thereby increasing the manufacturing cost. Therefore, there is an urgent demand for the study of a simplified control device in which the backflow prevention device and the flow control device are incorporated into a single device.

The information disclosed in this Background of the Invention section is only for the enhancement of understanding of the background of the invention, and should not be taken as an acknowledgment or any form of suggestion that this information forms a prior art that would already be known to a person skilled in the art.

### REFERENCE CITED

Korean Patent Application Publication No. 10-2011-0032041 (Mar. 30, 2011)

### BRIEF SUMMARY OF THE INVENTION

Various aspects of the present invention provide a flow controllable connector for home appliances in which a control device for performing both the function of supplying fluid at a constant rate and the function of preventing backflow is provided in order to improve the reliability of home appliances.

In an aspect of the present invention, there is provided a flow controllable connector for home appliances, which diverges or extends a passage of fluid by fastening an inlet having a first passage and an outlet having a second passage to tubes using fastening devices. The connector includes a control device disposed between the inlet and the outlet in order to prevent the fluid from flowing back as well as to control a flow rate. The control device includes a fixed member disposed between the first passage and the second passage; a movable member coupled to the fixed member, the movable member closing the first passage using an elastic force of an elastic member when the fluid flows back; and a variable member coupled to the fixed member, the variable member reciprocating depending on a pressure of the fluid, thereby varying the area of the second passage.

According to embodiments of the present invention, the flow controllable connector for home appliances has the following effects.

First, the connector is provided therein with the control device that performs both the function of preventing the fluid from flowing back and the function of controlling the pressure of the fluid. This can consequently prevent an electric/electronic sub-assembly from malfunctioning or abnormally operating, thereby increasing the longevity and reliability thereof.

Second, since the control device is configured such that it is fitted into the connector, the operation processing associated with the assembly and disassembly of the control device is simplified. Accordingly, maintenance cost is reduced, defects are prevented, and the connector can be mass produced.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a cross-sectional view showing the installation state of a connector according to an exemplary embodiment of the invention;

FIG. 2 is a cross-sectional view showing the state in which the connector shown in FIG. 1 properly operates;

FIG. 3 is a cross-sectional view showing the state in which the connector shown in FIG. 1 operates when backflow occurs; and

FIG. 4 is a cross-sectional view showing the connector shown in FIG. 1.

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments thereof, it is to be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

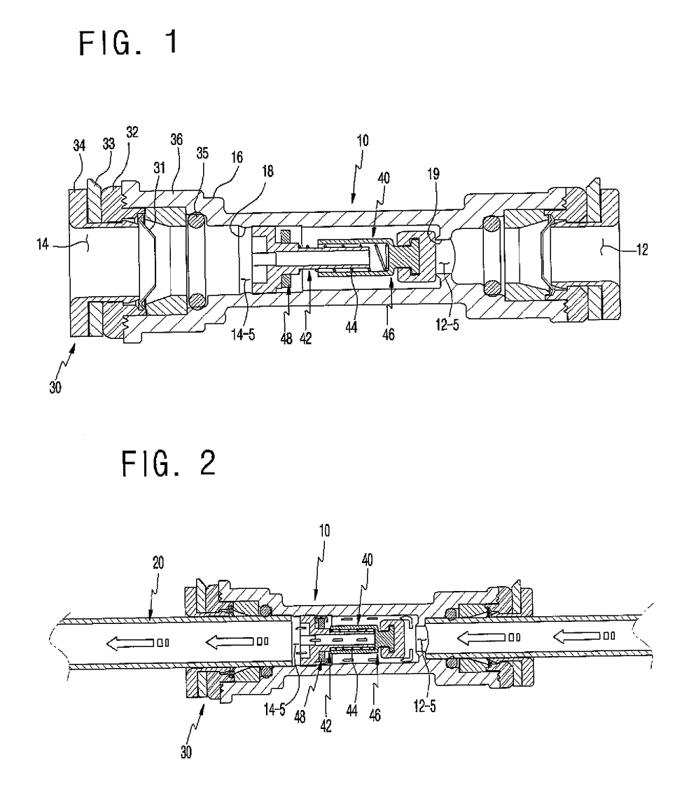

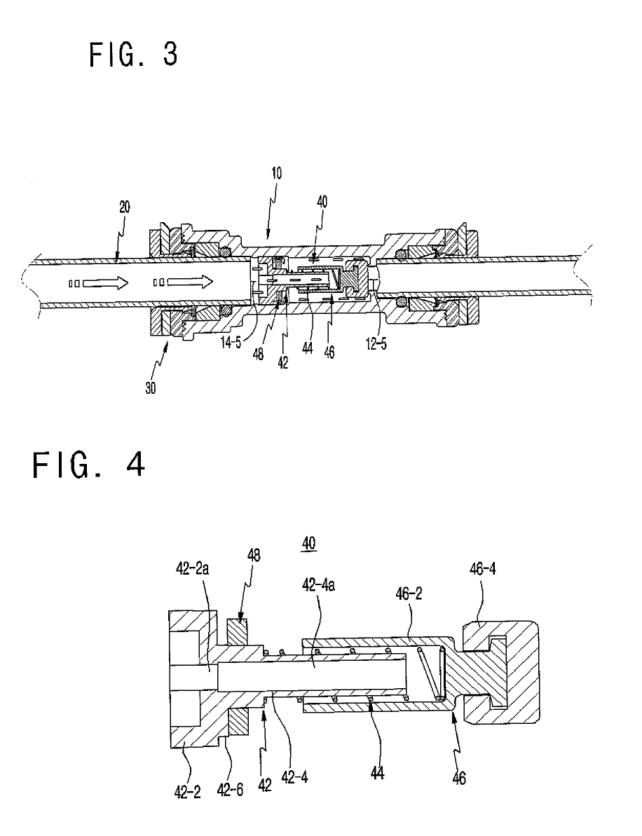

FIG. 1 is a cross-sectional view showing the installation state of a connector according to an exemplary embodiment of the invention, FIG. 2 is a cross-sectional view showing the state in which the connector shown in FIG. 1 properly operates, FIG. 3 is a cross-sectional view showing the state in which the connector shown in FIG. 1 operates when backflow occurs, and FIG. 4 is a cross-sectional view showing the connector shown in FIG. 1.

According to an exemplary embodiment of the invention, the flow controllable connector for home appliances is designed to diverge or extend a passage of fluid by fastening an inlet 12 having a first passage 12-5 and an outlet having a second passage 14-5 to tubes 20 using fastening devices 30. The connector includes a control device 40, which is disposed between the inlet 12 and the outlet 14 in order to prevent the fluid from flowing back as well as to control the flow rate. The control device 40 includes a fixed member 42 disposed between the first passage 12-5 and the second passage 14-5, a movable member 46 coupled to the fixed member 42, the movable member 46 closing the first passage 12-5 using the elastic force of an elastic member 44 when the fluid flows back, and a variable member 48 coupled to the fixed member 42, the variable member 48 reciprocating depending on the pressure of the fluid, thereby varying the area of the second passage 14-5.

First, in this embodiment, it is additionally noted that the control device 40 is coupled to the connector 10. In particular, the fixed member 42, the movable member 44 and the variable member 48 of the control device 40 are coupled together, such that the control device 40 performs dual functions of preventing the fluid from flowing back and controlling the flow rate.

In addition, the connector 10 includes a housing 16, the inlet 12, and the outlet 14. The housing 16 is a tubular body that is used in the process of supplying fluid to a home appliance, and forms the contour of the connector 10 and contains the control device 40 therein. The inlet 12 and the outlet 14 are provided on the opposite ends of the housing 16 to connect the tubes 20.

In addition, the first passage 12-5 is provided inside the inlet 12, and the second passage 14-5 is provided inside the outlet 14.

Here, the first passage 12-5 is a flow passage that extends through a wall formed in the inner portion of the inlet 12, and the second passage 14-5 is a flow passage that allows the control device 40, which is the key component of the present invention, to be inserted through.

It is preferred that a protrusion 19 be formed in the first passage 12-5 such that the protrusion 19 abuts against the movable member 46, and that a projection 18 be formed in the second passage 14-5 such that the projection 18 prevents the control means 40 from being dislodged.

In addition, the fastening devices 30 are disposed on objects, including the inlet 12 and the outlet 14. In each fastening device 30, a receptacle 32 is fixed to a corresponding object on which it is disposed, and has a lock ring 31. A movable body 34 is coupled to the inner circumference of the receptacle 32 via a clip 33, and contains a corresponding tube 20 therein.

It is also preferred that an O-ring 35 be provided on a path along which the movable body 34 moves, preferably, in the portion which abuts against the leading end of the tube 20 in order to form a seal 36, thereby prevent the joint of the tubes 20 from leaking.

Although this embodiment has been described with respect to the fastening device 30 in which the receptacle 32, the movable body 34 and the seal 36 are coupled together, any other devices in which the tube 20 can be separated or coupled with one touch in the process in which the movable body 34 is compressed or returned are embraced in the scope of the present invention.

In addition, the fixed member 42 includes a fixed head 42-2, which is fixedly received in the inner space of the housing 16, a cylindrical guide rod 42-4, which is formed on one portion of the fixed head 42-2, and a plurality of spacing protrusions 42-6, which are sequentially formed at predetermined intervals on one side of the fixed head 42-2.

Here, the fixed head 42-2 is fitted between the first passage 12-5 and the second passage 14-5 such that it is in close contact with the inner wall of the housing 16. The fixed head 42-2 has a passage 42-2a formed on the body thereof, the passage 42-2a facing the second passage 14-5.

The guide rod 42-4 elongates from one portion of the fixed head 42-2, such that it guides the route along which the movable body 46 and the variable member 48 move. The guide rod 42-4 has a passage 42-4a formed on the body thereof, the passage 42-4a communicating with the passage 42-2a.

The spacing protrusions 42-6 protrude from the circumference of the fixed head 42-2. Here, the area of the second passage 14-5 is varied by setting the interval to the movable member 48 to a predetermined value.

In addition, the movable member 46 is slidably coupled to the fixed member 42 in order to close the first passage 12-5 when the fluid flows back. The movable member 46 includes a closing head 46-4, which abuts against the first passage 12-5, and a movable cylinder 46-2, which is coupled to the closing head 46-4 such that it reciprocates following the fixed member 42.

The movable cylinder 46-2 is elastically coupled to the circumferential surface of the guide rod 42-2 via the elastic member 44, and reciprocates along the length of the guide rod 42-4 depending on the elastic force of the elastic member 44 or the pressure of the fluid.

The closing head 46-4 is coupled to or integrally formed on one end of the movable cylinder 46-2. When the fluid is caused to flow back by the second passage 14-5, the closing head 46-4 comes into contact with the protrusion 19, thereby closing the first passage 12-5.

Here, it is preferred that the closing head 46-4 be made of a buffering material such as rubber in order to maximize the effect in which the first passage 12-5 is closed.

In addition, the variable member 48 is mounted on the guide rod 42-4 of the fixed member 42, such that it reciprocates depending on the pressure of the fluid. The area of the second passage 14-5 is varied by adjusting the interval between the variable member 48 and the spacing protrusions 42-6.

A description will be given below of the operation of the connector according to the invention.

First, as shown in FIG. 2, when a suitable amount of fluid is supplied to the connector 10, the pressure of the fluid drives the movable member 46 of the control device 40 so that moves to the left in the figure against the elastic force of the elastic member 44.

In sequence, the fluid that is supplied to the first passage 12-4 at the inlet 12 passes through the passages 42-2a and 42-4a of the fixed member 42 and then through the second passage 14-5 before being supplied to the place where it is used.

In this process, the variable member 48 mounted on the guide rod 42-4 of the fixed member 42 freely moves to the left or right in the figure depending on the pressure of the fluid, thereby properly controlling the flow rate depending on the pressure of the fluid.

In the meantime, as shown in FIG. 3, when backflow occurs in the connector 10, the elastic member 44 drives the movable member 46 to the right in the figure, so that the closing head 46-4 closes the first passage 12-5.

In sequence, when the first passage 12-5 is closed by the closing head 46-4, the fluid that is flowing back from the outlet 14 is prevented from flowing back further into the first passage 12-5 and thus remains around the fixed member 42.

In this process, the variable member 48 mounted on the guide rod 42-4 of the fixed member 42 freely moves to the left or right in the figure depending on the pressure of the backflow, thereby blocking the backflow of the fluid to the most possible extent.

Accordingly, the interaction among the fixed member 42, the movable member 46 and the variable member 48 of the control device 40 makes it possible to control the pressure of the fluid that is supplied from the inlet 12 as well as to block the backflow of the fluid from the outlet 14, thereby enabling both the function of supplying the fluid at a constant rate and the function of preventing the backflow.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A flow controllable connector for home appliances, which diverges or extends a passage of fluid by fastening an inlet having a first passage and an outlet having a second passage to tubes using fastening devices, the connector comprising:
a control device disposed between the inlet and the outlet in order to prevent the fluid from flowing back as well as to control a flow rate, wherein the control device comprises:
a fixed member disposed between the first passage and the second passage;
a movable member coupled to the fixed member, the movable member closing the first passage using an elastic force of an elastic member when the fluid flows back; and
a variable member coupled to the fixed member, the variable member reciprocating depending on a pressure of the fluid, thereby varying the area of the second passage.

2. The flow controllable connector of claim 1, wherein the fixed member comprises:
a fixed head disposed between the first passage and the second passage to form the second passage;
a cylindrical guide rod formed on one portion of the fixed head to provide a route along which the variable member moves; and
a plurality of spacing protrusions sequentially formed on an inner wall of the fixed head to form a passage between the fixed head and the variable member.

3. The flow controllable connector of claim 1, wherein the movable member comprises:
a movable cylinder coupled to an outer circumference of the fixed member, the movable cylinder is allowed to reciprocate by the elastic member or under the pressure of the fluid; and
a closing head coupled to a side portion of the movable cylinder, the closing head closing the first passage when the fluid flows back.
